(19) United States
(12) Patent Application Publication
(10) Pub. No.: US 2025/0339862 A1
(43) Pub. Date: Nov. 6, 2025

(54) MILL HOUSINGS FOR PULVERIZER SYSTEMS

(71) Applicant: Maag Reduction, Inc., Kent, OH (US)

(72) Inventors: Alisha Konst, Roanoke, VA (US); Charles Bell, Youngstown, OH (US)

(21) Appl. No.: 19/194,925

(22) Filed: Apr. 30, 2025

Related U.S. Application Data
(60) Provisional application No. 63/641,616, filed on May 2, 2024.

(51) Int. Cl. B02C 13/288; B02C 7/02

(52) U.S. Cl. CPC B02C 13/288; B02C 7/02

(57) ABSTRACT

A mill housing of a pulverizer system. The mill housing may include a cutting chamber, and a plurality of air intake holes configured to introduce airflow into and in a direction tangential to the cutting chamber. The plurality of air intake holes may include two or more single air intake holes, two or more single air intake slots, or one or more groupings of air intake holes, spaced evenly around an exterior surface of the mill housing. Each of the one or more groupings of air intake holes may include two or more vertically aligned air intake holes. The holes, slots, or groupings of holes may be machined into the mill housing exterior at an angle so as to allow the intake of air to enter the mill housing tangentially to the circumference of the cutting chamber, resulting in a more polished particulate having a higher density and increased flowability.

### CROSS-REFERENCE TO RELATED APPLICATIONS

This application claims priority under 35 U.S.C. § 119 to U.S. Provisional Patent Application No. 63/641,616, filed May 2, 2024, entitled “MILL HOUSINGS FOR PULVERIZER SYSTEMS,” the entire contents of which are fully incorporated herein by reference.

### FIELD

The present invention relates to pulverizer system mill housings with enhanced operability, including mill housings for improved air flow.

### BACKGROUND

Pulverizer systems are used in the processing of polymers and other materials, and can range from small throughput units, such as for laboratory or pilot plant operations, to more extensive pulverizer systems used for medium to high throughputs. Existing pulverizer systems typically utilize a vacuum to pull ground material from a mill upwards and into a cyclone for further downstream processing. These systems can present challenges such as material spillage and vacuum limitations, e.g., providing sufficient enough suction to completely evacuate the material.

Accordingly, there is a need for an improved mill housing for a pulverizer system. Embodiments of the present disclosure are directed to these and other considerations.

### SUMMARY

In accordance with certain embodiments of the present disclosure, a mill housing of a pulverizer system is disclosed. The mill housing may include a cutting chamber, and one or more air intake holes. The one or more air intake holes may be configured to introduce airflow into and in a direction tangential to the cutting chamber. The one or more air intake holes may include one or more groupings of air intake holes disposed (e.g., spaced evenly) around an exterior surface of the mill housing. Each of the one or more groupings of air intake holes may include two or more air intake holes, preferably vertically aligned, but may also be angularly aligned or in a staggered configuration, as is within the scope of the invention. Though groupings of air intake holes is preferred, it may also be contemplated to use a single air intake hole, or an air intake slot, at each location around an exterior surface of the mill housing.

In accordance with certain embodiments of the present disclosure, a mill housing of a pulverizer system is disclosed. The mill housing may include a cutting chamber, and a plurality of air intake holes. The plurality of air intake holes may be configured to introduce airflow into and in a direction tangential to the cutting chamber. The plurality of air intake holes may include a plurality of groupings of air intake holes spaced evenly around a circumferential surface of the mill housing or the plurality of air intake holes may include a single air intake hole, or a single air intake slot, spaced evenly around a circumferential surface of the mill housing. Each of the plurality of groupings of air intake holes may include two, three, or more vertically aligned, angularly aligned, or staggered air intake holes.

In accordance with certain embodiments of the present disclosure, a mill housing of a pulverizer system is disclosed. The mill housing may include a cutting chamber, a circumferential surface, and a plurality of air intake holes configured to introduce airflow into and in a direction tangential to the cutting chamber. The plurality of air intake holes may include a plurality of groupings of air intake holes disposed around and set inward with respect to the circumferential surface. Each of the plurality of groupings of air intake holes may include two, three, or more vertically aligned air intake holes. In other embodiments, the plurality of air intake holes may include a single air intake hole, or a single air intake slot, disposed around and set inward with respect to the circumferential surface of the mill housing. Other configurations of the air intake holes may also be contemplated, within the scope of the invention, while maintaining a configuration to introduce airflow into and in a direction tangential to the cutting chamber.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a perspective view of an exemplary pulverizer system.

FIG. 2 is a perspective view of an exemplary pulverizer system.

FIG. 3 is a perspective view of a mill housing of an exemplary pulverizer system.

FIG. 4 is a perspective view of a mill housing, in accordance with certain embodiments of the present disclosure.

FIG. 5 is a perspective view of the mill housing of FIG. 4, in accordance with certain embodiments of the present disclosure.

FIG. 6 is a perspective view of the mill housing of FIG. 4, in accordance with certain embodiments of the present disclosure.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices and methods. Such other components not described herein may include, but are not limited to, for example, components developed after development of the disclosed technology.

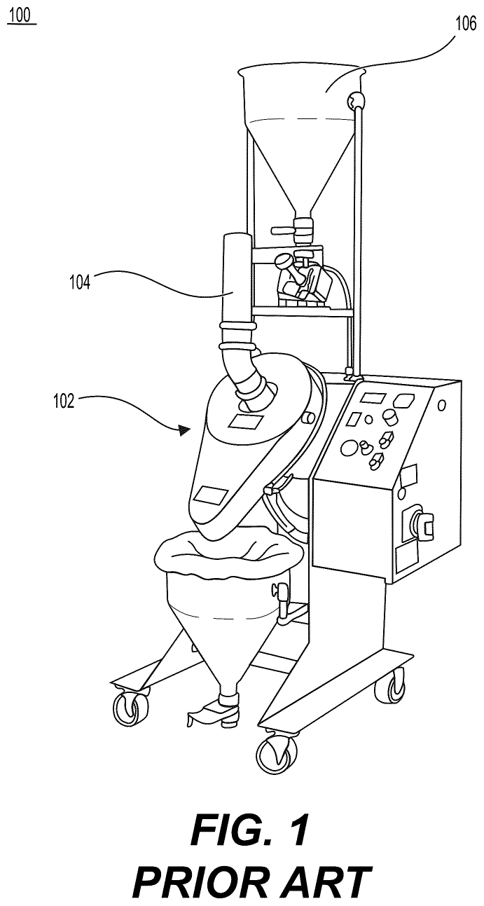

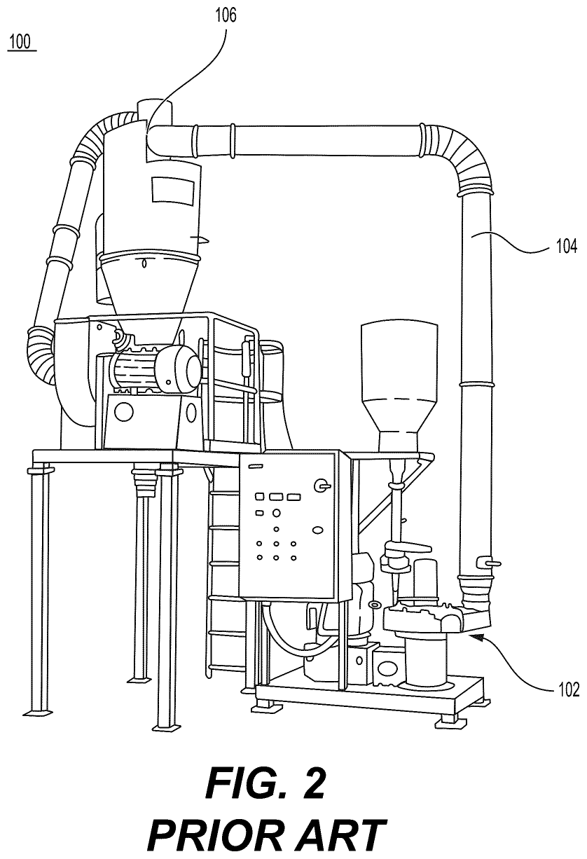

Pulverizer systems, such as those illustrated in FIGS. 1 and 2, are used in the processing of polymers and other materials. Current pulverizers can range from small throughput units, such as for laboratory or pilot plant operations (e.g., FIG. 1), to more extensive pulverizer systems used for medium to high throughputs (e.g., FIG. 2). Typical pulverizer systems, such as pulverizer system 100 depicted in FIGS. 1 and 2, may utilize a vacuum to pull ground material from a mill (e.g., mill 102) upwards through a material line (e.g., material line 104) and into a cyclone (e.g., cyclone 106) for further downstream processing. These typical pulverizer systems are commonly used to mill polymer pellets into polymer powders. The end use of these powders is most often for the roto molding industry, for molding various plastic parts and plastic items.

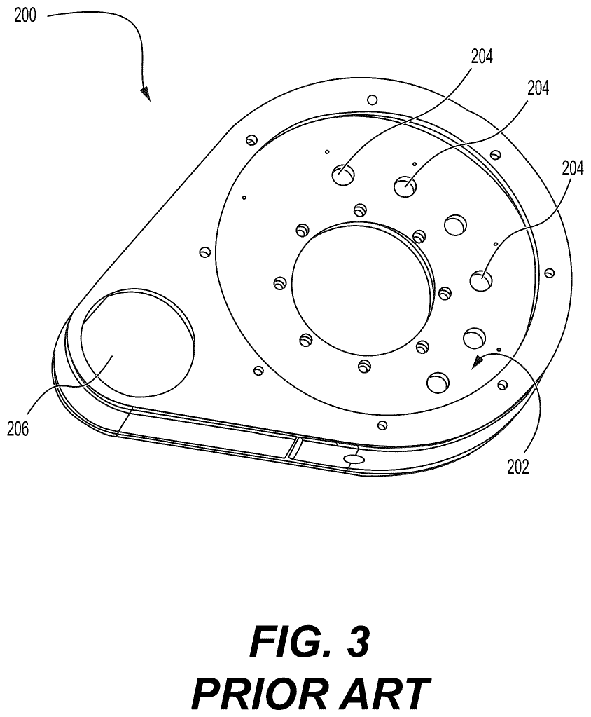

In order to accommodate sufficient air intake at the mill stage to evacuate the material, the mill housing can include air intake holes, such as along the top and/or bottom surfaces. For example, as illustrated in FIG. 3, a mill housing 200 may include one or more air intake holes 204 arranged in an arc on a bottom surface of the mill housing 200. The incoming air can interact with a flywheel or other rotating components within the cutting chamber (e.g., cutting chamber 202) of the mill housing before pulling the material out of the mill, such as through a material outlet 206. This interaction can result in turbulent airflow throughout the cutting chamber prior to the air being pulled upward through the material outlet. As such, existing mills can experience reduced throughput of material through the mill stage. Embodiments of the present disclosure are aimed at overcoming this and other challenges.

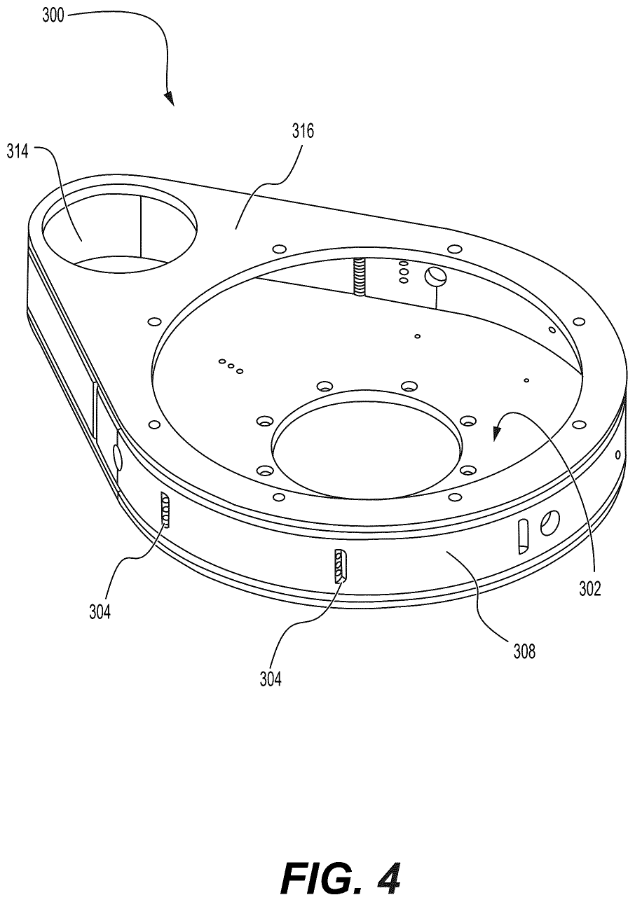

Reference will now be made in detail to exemplary embodiments of the disclosed technology, examples of which are illustrated in FIGS. 4-6, and disclosed herein. Wherever convenient, the same reference numbers will be used throughout the drawings to refer to the same or like parts.

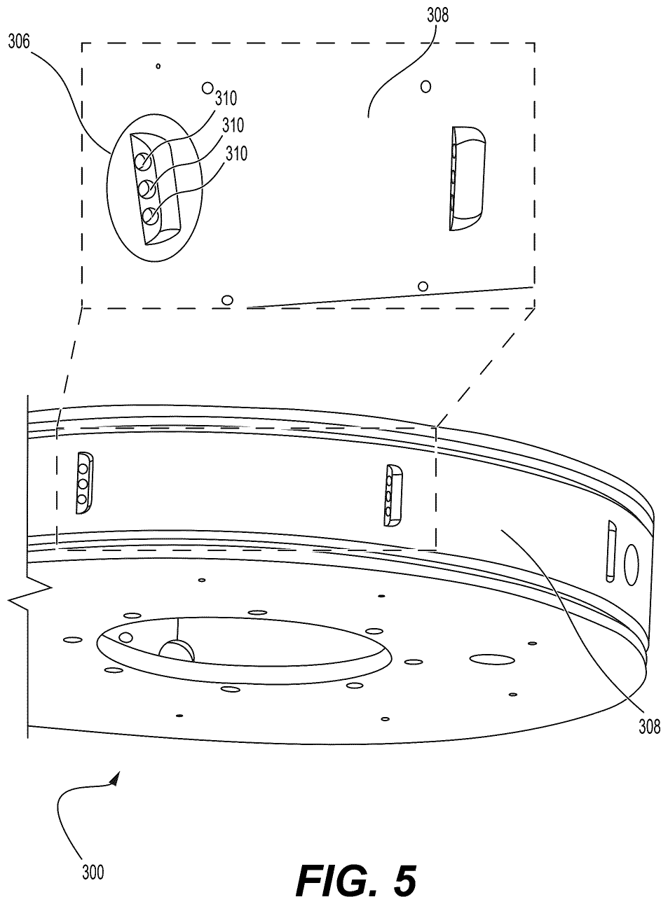

FIGS. 4-6 provide perspective views of a mill housing 300, in accordance with certain embodiments of the present disclosure. The mill housing 300 may include a cutting chamber 302, and one or more air intake holes 304. In some embodiments, the mill housing 300 may have a plurality of air intake holes 304. The air intake hole(s) 304 may be configured to introduce airflow into, and in a direction tangential to, the cutting chamber 302. The air intake hole(s) 304 may include one or more groupings of air intake holes 306 (e.g., one, two, three, four, five, or six groupings, etc.) disposed (e.g., spaced evenly) around an exterior surface 308, such as a circumference, of the mill housing 300. In some embodiments, the one or more groupings of air intake holes 306 may include one or more (e.g., two, three, etc.) vertically aligned air intake holes 310, as particularly shown in FIG. 5. Each of the air intake holes 310 may be angled in a direction of a spinning cutting disc (as further discussed below) so as to direct incoming airflow in a direction tangential to the circumference of the mill housing 300, and in a direction of a spinning cutting disc. In other embodiments (not shown), the air intake hole(s) 304 may take the form of one or more single holes, or single slots, arranged in a similar manner as the one or more groupings of air intake holes.

In some embodiments, as particularly shown in FIG. 5, each of the grouping(s) of air intake holes 306 may be set inward with respect to the exterior surface 308 of the mill housing 300. For example, rather than the grouping(s) of air intake holes 306 being flush with the exterior surface 308, the grouping(s) may each project or protrude inward (e.g., toward the cutting chamber 302) with respect to the exterior surface 308. These inward protruding grouping(s) of air intake holes 306 may be milled or machined into the exterior surface of the housing at the time of the housing manufacture.

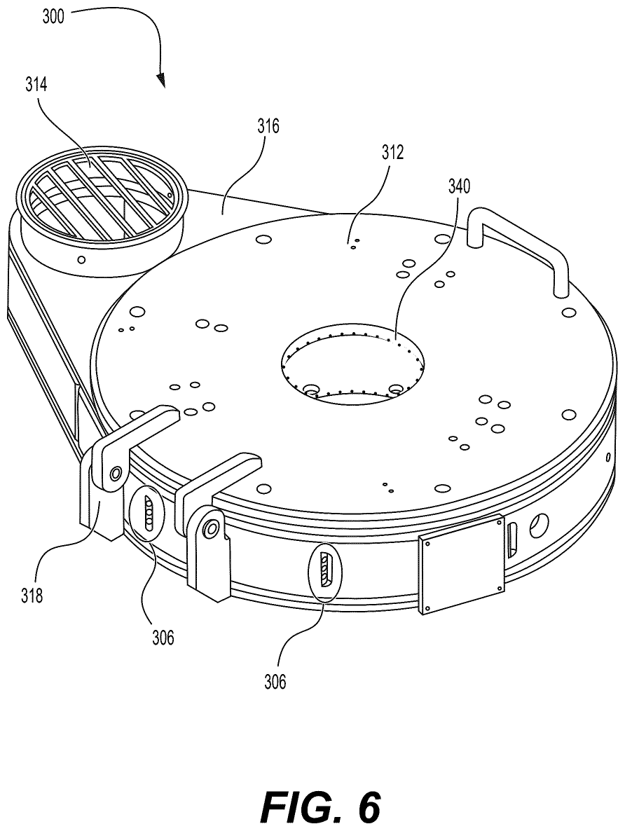

In some embodiments, the cutting chamber 302 may include a cutting disc 340 (a portion of which is shown in dotted lines in FIG. 6), e.g., to aid in the griding of the incoming material. The cutting disc 340 is configured to spin in cutting chamber 302. The air intake hole(s) 304 may be configured to introduce the airflow in a direction of the spinning cutting disc, and/or may be disposed adjacent to the cutting disc 340.

In some embodiments, the mill housing 300 may include a lid 312, as particularly shown in FIG. 6. The lid 312 may at least partially enclose the cutting chamber 302, and may be attached to the exterior surface 308 of the mill housing 300 (e.g., via a hinge 318).

In some embodiments, the mill housing 300 may include a material outlet 316 disposed on a first surface 316 of the mill housing 300, where the first surface 316 is a different surface from the external surface 308.

Such air intake hole configuration of the mill housing 300 may prevent the airflow from interacting with any rotating equipment (e.g., the cutting disc 340) inside the mill housing, which provides several advantages over prior orientations, as further discussed below. Redirecting the entrance points of the incoming air allows the incoming, cooler air to be directed directly at the ground material within the cutting chamber of the mill housing as the material leaves the cutting or grinding disc or discs.

The present disclosure provides additional advantages. The material in the mill should be ground at a high enough temperature to “polish” the material. This means the outer edges of the particulate melt back into the body after grinding. Having the air intake holes 304 arranged in groupings 306 around the exterior surface 308 of the mill housing 300 helps to move the material at a faster rate, allowing the mill to run at a higher temperature. A higher operating temperature means the mill feeder may run faster to maintain the temperature, which results in a greater yield (e.g., per hour) with the same energy consumed.

Further, the higher temperature and greater movement results in a greater percentage of the material being “polished.” This means a greater percentage of the particulate is being melted back into the body, resulting in a better polish or higher overall quality of the produced ground material (e.g., powder).

### Examples

A field trial of a prototype mill was performed, with the prototype mill having air intake holes as described above with respect to mill housing 300 of FIGS. 4-6.

The “polish,” as discussed above, is important for processes that use the ground powder downstream from the pulverizer system. In most cases, this is measured using a flow meter and cup. A flow meter is a funnel with a very specific shape, volume, and outlet size. The cup also has a specific volume that allows measuring the density of the material. One hundred grams of material are poured into the meter, the cup is placed under the funnel, and the port is then opened. The amount of time it takes for the material to empty out of the meter is measured, which equates to the flow. The material in the cup is then weighed, from which the density is determined.

The flow and density represent the measure of how compact the particulates are. The more the irregularly shaped particulates can be polished, the faster the flow time will be. The same principle applies to the density. A polished particulate will take less space, which means more material will fit in the cup.

During the trial, the inventors saw a 26% increase in the throughput of the mill employing mill housing 300 of the present invention compared to the throughput of a mill having a mill housing 200, as shown in FIG. 3. Further, the flow of the material improved from a timed volume average of 39.11 seconds to 31.83 seconds. This indicates that the material's flowability has increased, which will ultimately result in more uniform wall thicknesses of parts molded from the improved polymer powders. Finally, the density of the improved polymer powders produced by the mill of the present invention increased by 28%, as compared to the density of powders produced by prior art mills as shown in FIGS. 2 and 3. These numbers represent a significant improvement in the performance of the pulverizer system without any additional energy usage.

In some examples, disclosed systems or methods may involve one or more of the following clauses:

Clause 1: A mill housing of a pulverizer system, the mill housing comprising: a cutting chamber; and one or more air intake holes configured to introduce airflow into and in a direction tangential to the cutting chamber, the one or more air intake holes comprising one or more groupings of air intake holes disposed around an exterior surface of the mill housing, wherein each of the one or more groupings of air intake holes comprises two or more vertically aligned air intake holes.

Clause 2: The mill housing of clause 1, wherein the cutting chamber is configured to receive a cutting disc.

Clause 3: The mill housing of clause 2, wherein the plurality of air intake holes are configured to introduce the airflow in a direction of the cutting disc.

Clause 4: The mill housing of any of clauses 2-3, wherein the plurality of air intake holes are disposed adjacent to the cutting disc.

Clause 5: The mill housing of any of clauses 1-4, wherein the exterior surface of the mill housing comprises a circumference of the mill housing.

Clause 6: The mill housing of any of clauses 1-5, wherein the two or more vertically aligned air intake holes comprise three vertically aligned air intake holes.

Clause 7: The mill housing of any of clauses 1-6, wherein each of the one or more groupings of air intake holes are set inward with respect to the exterior surface of the mill housing.

Clause 8: The mill housing of any of clauses 1-7, further comprising: a lid configured to at least partially enclose the cutting chamber, wherein the lid is attached to the exterior surface of the mill housing.

Clause 9: The mill housing of any of clauses 1-8, further comprising: a material outlet disposed on a first surface of the mill housing, the first surface being different from the exterior surface of the mill housing.

Clause 10: A mill housing of a pulverizer system, the mill comprising: a cutting chamber; and a plurality of air intake holes configured to introduce airflow into and in a direction tangential to the cutting chamber, the plurality of air intake holes comprising a plurality of groupings of air intake holes spaced evenly around a circumferential surface of the mill housing, wherein each of the plurality of groupings of air intake holes comprises three vertically aligned air intake holes.

Clause 11: The mill housing of clause 10, wherein: the cutting chamber comprises a cutting disc; and the plurality of air intake holes are configured to introduce the airflow in a direction of the cutting disc, and are disposed adjacent to the cutting disc.

Clause 12: The mill housing of any of clauses 10-11, further comprising: a lid configured to at least partially enclose the cutting chamber, wherein the lid is attached to the circumferential surface of the mill housing.

Clause 13: The mill housing of clause 12, wherein the lid is attached to the circumferential surface of the mill housing via a hinge.

Clause 14: The mill housing of any of clauses 10-13, further comprising: a material outlet disposed on a first surface of the mill housing, the first surface being different from the circumferential surface of the mill housing.

Clause 15: The mill housing of any of clauses 10-14, wherein the plurality of groupings of air intake holes comprise at least five groupings of air intake holes.

Clause 16: A mill housing of a pulverizer system, the mill comprising: a cutting chamber; a circumferential surface; and a plurality of air intake holes configured to introduce airflow into and in a direction tangential to the cutting chamber, the plurality of air intake holes comprising a plurality of groupings of air intake holes disposed around and set inward with respect to the circumferential surface, wherein each of the plurality of groupings of air intake holes comprises three vertically aligned air intake holes.

Clause 17: The mill housing of clause 16, wherein the plurality of groupings of air intake holes comprise at least five groupings of air intake holes.

Clause 18: The mill housing of any of clauses 16-17, further comprising: a lid configured to at least partially enclose the cutting chamber, wherein the lid is attached to the exterior surface of the mill housing.

Clause 19: The mill housing of any of clauses 16-18, further comprising: a material outlet disposed on a first surface of the mill housing, the first surface being different from the circumferential surface of the mill housing.

Clause 20: The mill housing of any of clauses 16-19, wherein: the cutting chamber comprises a cutting disc; and the plurality of air intake holes are configured to introduce the airflow in a direction of the cutting disc, and are disposed adjacent to the cutting disc.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A mill housing of a pulverizer system, the mill housing comprising:
a cutting chamber; and
one or more air intake holes configured to introduce airflow into and in a direction tangential to the cutting chamber, the one or more air intake holes comprising one or more groupings of air intake holes disposed around an exterior surface of the mill housing,
wherein each of the one or more groupings of air intake holes comprises two or more vertically aligned air intake holes.

2. The mill housing of claim 1, wherein the cutting chamber is configured to receive a cutting disc.

3. The mill housing of claim 2, wherein the plurality of air intake holes are configured to introduce the airflow in a direction of the cutting disc.

4. The mill housing of claim 2, wherein the plurality of air intake holes are disposed adjacent to the cutting disc.

5. The mill housing of claim 1, wherein the exterior surface of the mill housing comprises a circumference of the mill housing.

6. The mill housing of claim 1, wherein the two or more vertically aligned air intake holes comprise three vertically aligned air intake holes.

7. The mill housing of claim 1, wherein each of the one or more groupings of air intake holes are set inward with respect to the exterior surface of the mill housing.

8. The mill housing of claim 1, further comprising:
a lid configured to at least partially enclose the cutting chamber, wherein the lid is attached to the exterior surface of the mill housing.

9. The mill housing of claim 1, further comprising:
a material outlet disposed on a first surface of the mill housing, the first surface being different from the exterior surface of the mill housing.

10. A mill housing of a pulverizer system, the mill comprising:
a cutting chamber; and
a plurality of air intake holes configured to introduce airflow into and in a direction tangential to the cutting chamber, the plurality of air intake holes comprising a plurality of groupings of air intake holes spaced evenly around a circumferential surface of the mill housing,
wherein each of the plurality of groupings of air intake holes comprises three vertically aligned air intake holes.

11. The mill housing of claim 10, wherein:
the cutting chamber comprises a cutting disc; and
the plurality of air intake holes are configured to introduce the airflow in a direction of the cutting disc, and are disposed adjacent to the cutting disc.

12. The mill housing of claim 10, further comprising:
a lid configured to at least partially enclose the cutting chamber, wherein the lid is attached to the circumferential surface of the mill housing.

13. The mill housing of claim 12, wherein the lid is attached to the circumferential surface of the mill housing via a hinge.

14. The mill housing of claim 10, further comprising:
a material outlet disposed on a first surface of the mill housing, the first surface being different from the circumferential surface of the mill housing.

15. The mill housing of claim 10, wherein the plurality of groupings of air intake holes comprise at least five groupings of air intake holes.

16. A mill housing of a pulverizer system, the mill comprising:
a cutting chamber;
a circumferential surface; and
a plurality of air intake holes configured to introduce airflow into and in a direction tangential to the cutting chamber, the plurality of air intake holes comprising a plurality of groupings of air intake holes disposed around and set inward with respect to the circumferential surface,
wherein each of the plurality of groupings of air intake holes comprises three vertically aligned air intake holes.

17. The mill housing of claim 16, wherein the plurality of groupings of air intake holes comprise at least five groupings of air intake holes.

18. The mill housing of claim 16, further comprising:
a lid configured to at least partially enclose the cutting chamber, wherein the lid is attached to the exterior surface of the mill housing.

19. The mill housing of claim 16, further comprising:
a material outlet disposed on a first surface of the mill housing, the first surface being different from the circumferential surface of the mill housing.

20. The mill housing of claim 16, wherein:
the cutting chamber comprises a cutting disc; and
the plurality of air intake holes are configured to introduce the airflow in a direction of the cutting disc, and are disposed adjacent to the cutting disc.
